(19) United States
(12) Patent Application Publication
(10) Pub. No.: US 2025/0377712 A1
(43) Pub. Date: Dec. 11, 2025

(54) Subsystem Operating Voltage Management

(71) Applicant: QUALCOMM Incorporated, San Diego, CA (US)

(72) Inventors: Vijayakumar Ashok DIBBAD, Bangalore (IN); Mahadevamurty NEMANI, San Diego, CA (US); Anish MUTTREJA, Pittsford, NY (US); Nikhil Ashok BHELAVE, Gondiya (IN); Hoan Huu NGUYEN, Cary, NC (US)

(21) Appl. No.: 18/738,781

(22) Filed: Jun. 10, 2024

(51) Int. Cl. G06F 1/3296; H04L 67/30

(52) U.S. Cl. CPC G06F 1/3296; H04L 67/30

(57) ABSTRACT

Various embodiments include methods performed by a processor system of a computing device for dynamically adjusting voltages for client components. The processor system may identify a potential current profile for a client use case, identify a voltage reduction for the client use case, and transmit the voltage reduction for the client use case to a system power manager. The processor system may identify the potential current profile for the client use case based on a maximum current for the client and a potential maximum current for the client use case. The processor system may cause the system power manager to reduce a client voltage to a voltage level that maintains client voltage at a level greater than a minimum client voltage during a voltage droop caused by a potential maximum current for the client use case.

### BACKGROUND

Power management for computing device components is used to manage costs of and conditions for running components of a computing device. Power supplied to the components of the computing device may be configured for various purposes, including the operation of the components. The power supply may be configured to maintain sufficient power to the components for their operation regardless of the power requirements of the components. For example, the power supply may be configured to maintain sufficient for worst-case scenarios of the greatest power requirements of the components regardless of whether the components currently require that much power. In other words, a stable power supply may be provided to the components during operation with the power supply configured to avoid voltage droop during worst-case scenarios of greatest power demands by any components.

### SUMMARY

Various aspects provide methods and apparatuses for implementing such methods for providing dynamic voltage adjustment for a client of a computing device. Various aspects may include identifying a potential current profile for a use case for the client, identifying a voltage reduction for the use case for the client based in part on the potential current profile for the use case for the client, and transmitting the voltage reduction for the use case for the client to a system power manager.

In some aspects, identifying the potential current profile for the use case for the client may include retrieving a maximum current for the client from a memory, identifying a potential maximum current for the use case for the client, and identifying the potential current profile for the use case for the client based on the maximum current for the client and the potential maximum current for the use case for the client. In some aspects, the voltage reduction for the use case for the client may be configured to indicate to the system power manager to reduce a voltage to the client to a voltage level that maintains the voltage to the client at a level greater than a minimum voltage for the client during an occurrence of voltage droop corresponding to the potential maximum current for the use case for the client. In some aspects, identifying the potential maximum current for the use case for the client may include calculating the potential maximum current for the use case for the client based on pending work for the use case for the client. In some aspects, identifying the potential maximum current for the use case for the client may include retrieving the potential maximum current for the use case for the client from the memory.

In some aspects, identifying the voltage reduction for the use case for the client based in part on the potential current profile for the use case for the client may include retrieving a peak impedance for the client from a memory, and identifying the voltage reduction for the use case for the client based on the potential current profile for the use case for the client and the peak impedance for the client.

Further aspects include a computing device including a memory and a processor configured to perform operations of any of the methods summarized above. Further aspects include a non-transitory processor system-readable storage medium having stored thereon processor system-executable software instructions configured to cause a processor to perform operations of any of the methods summarized above. Further aspects include a computing device having means for accomplishing functions of any of the methods summarized above.

### BRIEF DESCRIPTION OF THE DRAWINGS

The accompanying drawings, which are incorporated herein and constitute part of this specification, illustrate example embodiments of various embodiments, and together with the general description given above and the detailed description given below, serve to explain the features of the claims.

FIG. 1 is a component block diagram illustrating an example computing device suitable for implementing various embodiments.

FIG. 2 is a component block diagram illustrating an example peripheral device system suitable for implementing various embodiments.

FIG. 3 is a component block diagram illustrating an example processor system of a computing device configured for implementing dynamic voltage adjustment for a client of a computing device for implementing various embodiments.

FIG. 4 is a component block diagram illustrating an example power management system configured for implementing dynamic voltage adjustment for a client of a computing device for implementing various embodiments.

FIGS. 5A and 5B are timing diagrams illustrating an example of dynamic voltage adjustment for a client of a computing device in accordance with various embodiments.

FIG. 6 is a process flow diagram illustrating an example method for dynamic voltage adjustment for a client of a computing device in accordance with various embodiments.

FIG. 7 is a process flow diagram illustrating an example method for identifying a potential current profile for a use case at a client in accordance with various embodiments.

FIG. 8 is a process flow diagram illustrating an example method for identifying a voltage reduction for a use case at a client in accordance with various embodiments.

FIG. 9 is a process flow diagram illustrating an example method for dynamic voltage adjustment for a client of a computing device in accordance with various embodiments.

FIG. 10 is a component block diagram illustrating an example mobile computing device suitable for implementing various embodiments.

FIG. 11 is a component block diagram illustrating an example mobile computing device suitable for implementing various embodiments.

FIG. 12 is a component block diagram illustrating an example server suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes and are not intended to limit the scope of the claims.

Various embodiments include methods and computing devices implementing such methods for dynamically managing subsystem operating voltages. Some embodiments may include identifying a potential current profile for a use case for a client component (referred to herein as a “client”), identifying a voltage reduction for the use case for the client based in part on the potential current profile for the use case for the client, and transmitting the voltage reduction for the use case for the client to a system power manager. In some embodiments, the potential current profile for the use case for the client may be based on a maximum current for the client and a potential maximum current for the use case for the client. In some embodiments, the voltage reduction for the use case for the client may be based on the potential current profile for the use case for the client and a peak impedance for the client. In some embodiments, the voltage reduction for the use case for the client may be configured to indicate to the system power manager that a voltage to the client should be reduced to a voltage level that maintains the voltage to the client at a level greater than a minimum voltage for the client during an occurrence of voltage droop corresponding to the potential maximum current for the use case for the client.

The term “computing device” is used herein to refer to stationary computing devices, including personal computers, desktop computers, all-in-one computers, workstations, supercomputers, mainframe computers, embedded computers (such as in vehicles and other larger systems), computing systems within or configured for use in vehicles, servers, multimedia computers, and game consoles. The terms “computing device” and “mobile computing device” are used interchangeably herein to refer to any one or all of cellular telephones, smartphones, personal or mobile multi-media players, personal data assistants (PDAs), laptop computers, tablet computers, convertible laptops/tablets (2-in-1 computers), smartbooks, ultrabooks, netbooks, palm-top computers, wireless electronic mail receivers, multimedia Internet-enabled cellular telephones, mobile gaming consoles, wireless gaming controllers, and computing systems embedded in vehicles that include a memory, and a programmable processor.

Various embodiments are described in terms of code, e.g., processor system-executable instructions, for ease and clarity of explanation, but may be similarly applicable to any data, e.g., code, program data, or other information stored in memory. The terms “code,” “data,” and “information” are used interchangeably herein and are not intended to limit the scope of the claims and descriptions to the types of code, data, or information used as examples in describing various embodiments.

Power management for computing device components is used to manage costs of and conditions for running components of a computing device. Power supplied to the components of the computing device may be configured for various purposes, including the operation of the components. The power supply may be configured to maintain sufficient power to the components for operation of the components regardless of the power requirements of the components. For example, the power supply may be configured to maintain sufficient power to the components for operation of the components in worst-case scenarios of greatest power requirements of the components regardless of whether the components require the greatest power requirements of the components. In other words, during the operation of the components, a static power supply may be provided to the components. The power supply may be configured to avoid voltage droop during the worst-case scenarios of maximum power requirements of the components affecting the operation of the components.

During normal operations, components may not always require the maximum power level (i.e., operate with the greatest power requirements of the components). Rather, components may infrequently, even rarely if ever, require power at or near their greatest power requirement. Therefore, in most circumstances, providing a static (i.e., stable) power supply equal to the greatest power requirement for the components provides excess power that is wasted. Providing excess power to components during operation results in an unnecessary power cost that may unnecessarily deplete battery power reserves, increase thermal heating of components, wear out the components, reduce component reliability, and increase financial operating costs due to excess power consumption and shortened component operational lifespan.

Various embodiments overcome the foregoing problems of a static power supply that always meets the greatest power requirements of components by implementing dynamic voltage adjustments for client components of computing devices. Various embodiments may include dynamically adjusting the voltage supplied to the client on a use case basis. A current use case of the client may have a worst-case (i.e., greatest) power requirement that is less than the design or general worst-case scenario of the greatest power requirement of the client. As such, a voltage provided to the client during the use case to account for the general worst-case of greatest power requirement of the client may be greater than may be used by the client. Even in the worst case of the greatest power requirement of the client for or during the use case, the client may use less voltage than is provided by the power supply. Dynamically adjusting the voltage provided to the client per various embodiments may reduce the voltage level sufficient to account for the greatest power requirement of the client for/during the use case. Dynamic adjustment of the voltage to the client for or during the use case may reduce the voltage provided to the client, thereby minimizing the amount of excess power provided to the client.

Many use cases may have worst-case scenarios of greatest power requirements of the client that are less than a general worst-case scenario of greatest power requirement of the client. Each dynamic voltage adjustment for such use cases may individually and cumulatively reduce power consumption and wear of the client and power provisioning components of the computing device. Each dynamic voltage adjustment for such use cases may individually and cumulatively reduce consumption of power resources of the battery of the computing device, reduce thermal profiles of the components, reduce wear of components due to receiving greater than necessary power, increase reliability of the components, and reduce the financial operating cost due to power consumption and component health.

Various embodiments may include a processor system configured to identify a potential current profile for a use case for the client, identify a voltage reduction for the use case for the client based in part on the potential current profile for the use case for the client, and transmit the voltage reduction for the use case for the client to a system power manager. The potential current profile may be based on a maximum current for the client and a potential maximum current for the use case for the client and may be configured to indicate a current usage over a duration for the client implementing the use case. The maximum current for the client may be a predetermined value retrieved from memory. The potential maximum current for the use case for the client may be a value calculated or retrieved from memory based on the work or operation of the client for the work or operation involved in implementing the use case.

The voltage reduction may be based on the potential current profile and a peak impedance for the client. The peak impedance for the client may be a value configured to indicate a peak impedance between a system power manager and the client based on the current frequencies of the potential current profile. The voltage reduction may be configured to indicate to the system power manager a voltage level to or an amount of voltage by which to reduce the voltage to the client, such that the voltage to the client remains above a minimum voltage during a voltage droop corresponding to the potential maximum current for the use case for the client.

The power system manager may receive the voltage reduction from the client and interpret the voltage reduction to dynamically adjust the voltage to the client. The power system manager may reduce the voltage to the client by the level or by the amount of voltage indicated by the voltage reduction.

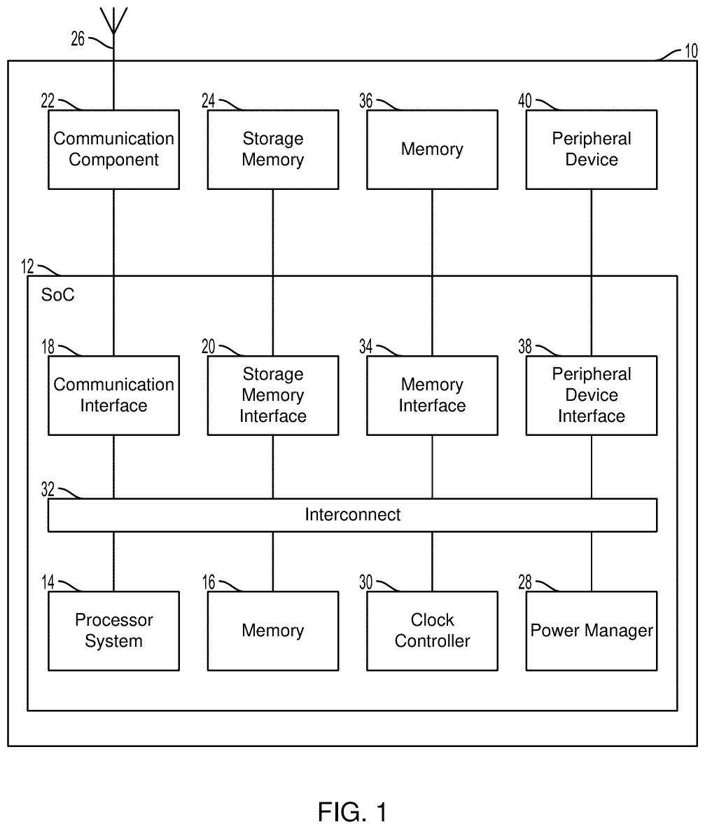

FIG. 1 illustrates a system including a computing device 10 suitable for use with various embodiments. With reference to FIG. 1, the computing device 10 may include a system-on-chip (SoC) 12 with a processor system 14, a memory 16, a communication interface 18, a storage memory interface 20, a memory interface 34, a power manager 28, a clock controller 30, a peripheral device interface 38, and an interconnect 32. The computing device 10 may further include a communication component 22, such as a wired or wireless modem, a storage memory 24, an antenna 26 for establishing a wireless communication link, a memory 36, and a peripheral device 40. The processor system 14 may refer to one or more processing devices, for example, one or more processors or one or more processor cores. The processor system 14 may include any of a variety of processing devices, including multiple processor cores.

The term “system-on-chip” (SoC) is used herein to refer to a set of interconnected electronic circuits typically, but not exclusively, including a processing device, a memory, and a communication interface. A processor system 14 may include a variety of different types of processors and processor cores, such as a general-purpose processor, a central processing unit (CPU), a digital signal processor (DSP), a graphics processing unit (GPU), an accelerated processing unit (APU), a secure processing unit (SPU), an artificial intelligence processing unit (AIPU), a subsystem processor of specific components of the computing device, such as an image processor for a camera subsystem or a display processor for a display, an auxiliary processor, a single-core processor, a multicore processor, a controller, and a microcontroller. A processor system 14 may further embody other hardware and hardware combinations, such as a field programmable gate array (FPGA), an application-specific integrated circuit (ASIC), other programmable logic devices, discrete gate logic, transistor logic, performance monitoring hardware, watchdog hardware, and time references. Integrated circuits may be configured such that the components of the integrated circuit reside on a single piece of semiconductor material, such as silicon.

An SoC 12 may include one or more processor systems 14. The computing device 10 may include more than one SoC 12, thereby increasing the number of processor systems 14, processors, and processor cores. The computing device ten may also include processor systems 14 that are not associated with an SoC 12. The processor systems 14 may each be configured for specific purposes that may be the same as or different from other processor systems 14 of the computing device 10. One or more of the processor systems 14, processors, or processor cores, of the same or different configurations may be grouped together. A group of processor systems 14, processors, or processor cores may be referred to as a multi-processor system cluster.

The memory 16, 36 for the SoC 12 may be a volatile or nonvolatile memory configured for storing data and processor system executable code for access by the processor system 14. The computing device 10 and/or SoC 12 may include one or more memories 16, 36 configured for various purposes. One or more memories 16, 36 may include volatile memories such as random access memory (RAM) or main memory or cache memory. For example, the memories 16, 36 may include any of static RAM (SRAM), dynamic RAM (DRAM), etc. These memories 16, 36 may be configured to temporarily hold a limited amount of data received from a data sensor or subsystem, data and/or processor system-executable code instructions that are requested from a nonvolatile memory 16, 24, loaded to the memories 16, 36 from the nonvolatile memory 16, 24 in anticipation of future access based on a variety of factors, and/or intermediary processing data and/or processor system-executable code instructions produced by the processor system 14 and temporarily stored for future quick access without being stored in nonvolatile memory 16, 24. The memory 16, 36 may include multiple physical memory components, such as memory chips, that may be logically combined and/or separated to form the memory 16, 36. The memory interface 34 and the memory 36 may work in unison to allow the computing device 10 to load and retrieve data and processor system-executable code on the memory 36.

The storage memory interface 20 and the storage memory 24 may work in unison to allow the computing device 10 to store data and processor system-executable code on a nonvolatile storage medium. The storage memory 24 may be configured much like an embodiment of the memory 16 in which the storage memory 24 may store the data or processor system-executable code for access by one or more of the processor systems 14. The storage memory 24, being nonvolatile, may retain the information after the power of the computing device 10 has been shut off. When the power is turned back on and the computing device 10 reboots, the information stored on the storage memory 24 may be available to the computing device 10. The storage memory 24 may include multiple physical memory components, such as storage memory drives, chips, discs, etc., that may be logically combined and/or separated to form the storage memory 24. The storage memory interface 20 may control access to the storage memory 24 and allow the processor system 14 to read data from and write data to the storage memory 24.

The power manager 28 may be configured to control power states of one or more power rails (not shown) for power delivery to the components of the SoC 12. In some embodiments, the power manager 28 may be configured to control the amounts of power provided to the components of the SoC 12. For example, the power manager 28 may be configured to control connections between components of the SoC 12 and the power rails. As another example, the power manager 28 may be configured to control amounts of power on the power rails connected to the components of the SoC 12. The power manager 28 may be configured as a power management integrated circuit (power management ICs or PMIC).

A clock controller 30 may be configured to control clock signals transmitted to the components of the SoC 12. For example, the clock controller 30 may gate a component of the SoC 12 by disconnecting the component of the SoC 12 from a clock signal and may ungate the component of the SoC 12 by connecting the component of the SoC 12 to the clock signal.

A peripheral device interface 38 may enable components of the SoC 12, such as the processor system 14 and/or the memory 16, to communicate with a peripheral device 40. The peripheral device interface 38 may provide and manage physical and logical connections between the components of the SoC 12 and the peripheral device 40. The peripheral device interface 38 may also manage communication between the components of the SoC 12 and the peripheral device 40, such as by directing and/or allowing communications between transmitter and receiver pairs of the components of the SoC 12 and the peripheral device 40 for a communication. The communications may include the transmission of memory access commands, addresses, data, interrupt signals, state signals, etc. A peripheral device 40 may be any component of the computing device 10 separate from the SoC 12, such as a processor system, a memory, a subsystem, etc. In some embodiments, the peripheral device interface 38 may include a PCIe root complex and may enable PCIe protocol communication between the components of the SoC 12 and the peripheral device 40. In some embodiments, the peripheral device 40 may be a component of the SoC 12.

The interconnect 32 may be a communication fabric, such as a communication bus, configured to communicatively connect the components of the SoC 12. The interconnect 32 may transmit signals between the components of the SoC 12. In some embodiments, the interconnect 32 may be configured to control signals between the components of the SoC 12 by controlling the timing and/or transmission paths of the signals.

Some or all of the components, including components of the SoC 12, connected to the SoC 12, and the SoC 12, of the computing device 10 may be arranged differently, separated, and/or combined while still serving the functions of the various embodiments. The computing device 10 may not be limited to one of each of the components, and multiple instances of each component may be included in various configurations of the computing device.

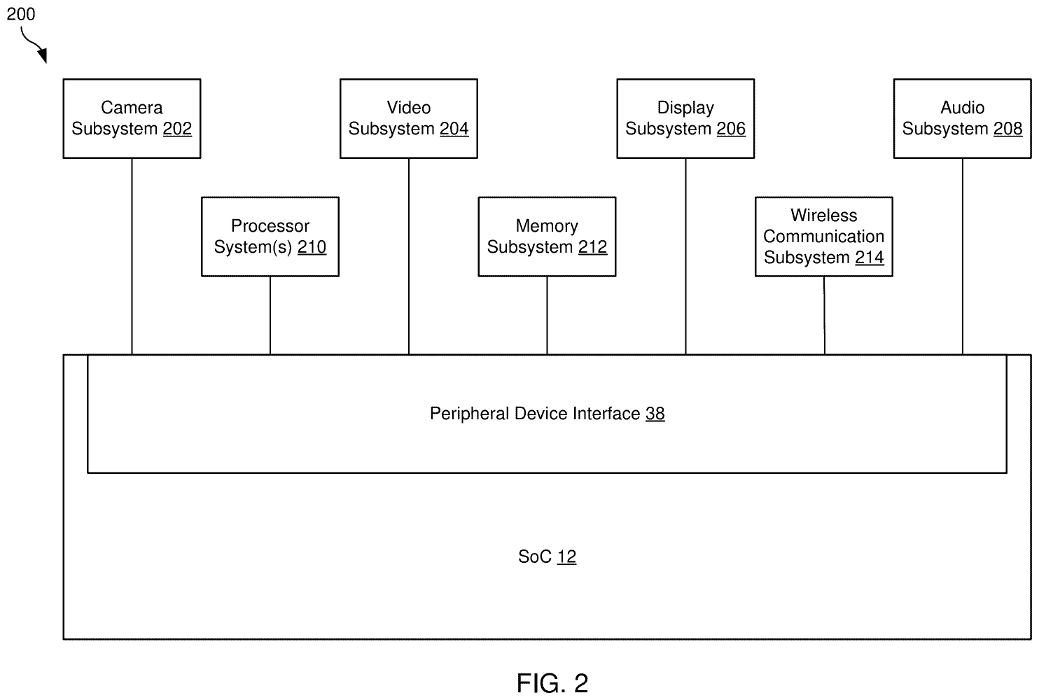

FIG. 2 illustrates an example subsystem system 200 suitable for implementing various embodiments. With reference to FIGS. 1 and 2, the subsystem system 200 may include any number and combination of subsystems 202, 204, 206, 208, 210, 212, 214 (e.g., peripheral device 40 in FIG. 2) communicatively connected to one or more peripheral device interfaces 38 of an SoC 12.

A peripheral device interface 38 may communicatively connect one or more subsystems 202, 204, 206, 208, 210, 212, 214 with one or more components of the SoC 12 as described, including a processor system (e.g., processor system 14 in FIG. 1) and/or a memory (e.g., memory 16 in FIG. 1). The processor system may include any number and combination of CPUs, GPUs, DSPs, APUs, SPUs, AIPUs, etc. The memory may include any number and combination of system caches, random access memories (RAM), registers, FLASH, EPROM, etc. Communicatively connecting a subsystem 202, 204, 206, 208, 210, 212, 214 with a component of the SoC 12 via the peripheral device interface 38 may enable transmission of communications between the subsystems 202, 204, 206, 208, 210, 212, 214 and the component of the SoC 12. Such communications may include memory access commands, addresses, data, interrupt signals, state signals, etc. In some examples, the peripheral device interface 38 may be a PCIe root complex of a PCIe system and enable PCIe protocol communication between the components of the SoC 12 and the one or more subsystems 202, 204, 206, 208, 210, 212, 214.

In some embodiments, the subsystems may include one or more processor systems 210 (e.g., processor system 14 in FIG. 1), such as a processor system or processor system cluster separate from the SoC 12. For example, a processor system 210 may include any number and combination of CPUs, GPUs, DSPs, APUs, SPUs, AIPUs, etc. In some embodiments, the subsystem may include various subsystems (e.g., communication component 22, storage memory 24, memory 36, peripheral device 40 in FIG. 1) having one or more processor systems (e.g., processor system 14 in FIG. 1) and memories (e.g., memory 16, 24, 36 in FIG. 1), such as camera, video, display, audio, memory, and wireless communication subsystems 202, 204, 206, 208, 212, 214. A processor system may include any number and combination of CPUs, GPUs, DSPs, APUs, SPUS, AIPUs, etc. A memory may include any number and combination of caches, RAM, registers, FLASH, EPROM, etc. In some embodiments, the subsystems 202, 204, 206, 208, 210, 212, 214 may include any number and combination of sensors, receivers, transmitters, controllers, and dedicated memories, such as caches and memory registers, configured for controlling and implementing functionalities of the subsystems 202, 204, 206, 208, 210, 212, 214. In some examples, the subsystems 202, 204, 206, 208, 210, 212, 214 may include and/or be connected to a PCIe system endpoint configured to enable PCIe protocol communication between the subsystems 202, 204, 206, 208, 210, 212, 214 and one or more components of the SoC 12.

The descriptions of the subsystems 202, 204, 206, 208, 210, 212, 214 illustrated in FIG. 2 are only meant to be examples and in no way limiting. Several of the components of the illustrated example subsystems 202, 204, 206, 208, 210, 212, 214 may be variably configured, combined, and separated. Several of the subsystems 202, 204, 206, 208, 210, 212, 214 may be included in greater or fewer numbers and may be located and connected differently than illustrated.

The term “client” herein may refer to any one or more components of an SoC 12 (e.g., SoC 12 in FIGS. 1 and 2) or subsystem (e.g., communication component 22, storage memory 24, memory 36, peripheral device 40 in FIG. 1, subsystems 202, 204, 206, 208, 210, 212, 214 in FIG. 2). For non-limiting example, such components may include a processor system (e.g., processor system 14, 210 in FIGS. 1 and 2) such as any number and combination of CPUs, GPUs, DSPs, APUs, SPUs, AIPUs, etc., including any cores, memories (e.g., memory 16 in FIG. 1) or integrated circuits included on the same chip or in the same package.

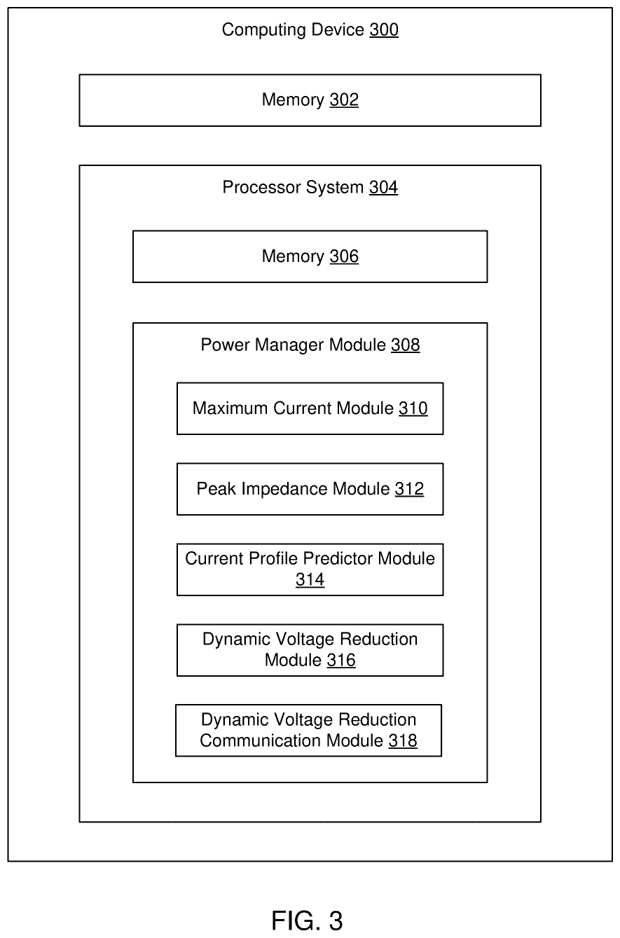

FIG. 3 illustrates an example processor system 304 (e.g., processor system 14, 210 in FIGS. 1 and 2) of a computing device 300 (e.g., computing device 10 in FIG. 1) configured for implementing dynamic voltage adjustment for a client of the computing device for implementing various embodiments. With reference to FIGS. 1-3, the processor system 304 may include one or more other modules 310-318 described further herein. Any one or more of the modules 310-318 may be implemented in hardware, software, firmware, or any combination thereof.

The processor system 304 may be configured with processor system-executable instructions of the one or more modules 310-318 for implementing functions of the one or more modules 310-318. The processor system 304 may be an integral component of an SoC (e.g., SoC 12 in FIGS. 1 and 2) or other components or subsystems (e.g., processor system 14, memory 16, communication interface 18, storage memory interface 20, memory interface 34, peripheral device interface 38, communication component 22, storage memory 24, memory 36, peripheral device 40 in FIG. 1, subsystems 202, 204, 206, 208, 210, 212, 214 in FIG. 2) of the computing device. The computing device may include a memory 302 (e.g., memory 16, 36, storage memory 24 in FIG. 1) that may be a non-transitory processor system-readable medium storing the processor system-executable instructions of the one or more modules 310-318 for implementing functions of the one or more modules 310-318. The processor system 304 may include a memory 306 (e.g., memory 16, 36 in FIG. 1) that may be a non-transitory processor system-readable medium storing the processor system-executable instructions of the one or more modules 310-318 for implementing functions of the one or more modules 310-318.

A maximum current module 310 may be configured to retrieve a maximum current for the client from the memory 302, 306. Each type of client may undergo testing during design and testing phases of manufacturing of the clients or the computing device. The clients may be put through tests to test the limits of operation of the clients under various circumstances. Various measurements of the conditions of the tests may be recorded and stored to the memory 302, 306 as client information configured to indicate maximum condition values for the limits of operation of the clients. Maximum currents may be the maximum current draws by the clients during the tests and may be included in the client information stored in memory 302, 306. The maximum currents may be values configured to represent to the processor system 304 maximum amounts of current required by the clients. For example, the maximum currents may be values configured to represent to the processor system 304 maximum amounts of current required by the clients from among all implemented tests. The maximum current module 310 may be configured to retrieve the maximum current for the client from the memory 302, 306. The maximum current module 310 may also be configured to interpret the maximum current for the client for use in algorithms, heuristics, or other calculation or decision-making processes.

A peak impedance module 312 may be configured to identify a peak impedance to the client based on a frequency of current to the client. The peak impedance module 312 may be configured to retrieve the peak impedance to the client from the memory 302, 306. In some embodiments, during the design and testing phases of manufacturing of the clients or the computing device, the peak impedances may be measured based on the impedances of components electrically connecting system power managers (e.g., power manager 28 in FIG. 1) and the clients for frequencies of the currents used in testing the clients. In some embodiments, during the design and testing phases of manufacturing of the clients or the computing device, the peak impedances may be calculated based on the impedances of components electrically connecting the system power managers and the clients for any frequencies of the currents that may be provided to the clients. Peak impedances to the clients may be included in the client information stored in the memory 302, 306. Peak impedances may be values configured to represent to the processor system 304 the greatest amounts of impedance between the system power managers and the clients. The peak impedance module 312 may be configured to retrieve the peak impedance to the client from the memory 302, 306. The peak impedance module 312 may also be configured to interpret the peak impedance to the client for use in algorithms, heuristics, or other calculation or decision-making processes.

A current profile predictor module 314 may be configured to identify a potential current profile for a use case for the client. Potential current profiles may be values configured to indicate to the processor system 304 current usage by the clients for use cases. In some embodiments, potential current profiles may be based on potential maximum currents for the clients for the use cases. In some embodiments, use cases may be based on work pending for the clients, such as in a scheduler queue, states of the computing device or the clients that may trigger certain work, etc.

In some embodiments, the current profile predictor module 314 may implement one or more algorithms, heuristics, or other calculation or decision-making processes to identify potential current profiles for use cases of the clients. For example, the current profile predictor module 314 may identify what work the clients may implement or how the clients may implement work for the use cases, such as based on workloads, instruction sets, frequencies, or operations (e.g., a shader calculation in a GPU) for the use cases. In some embodiments, what work the clients may implement or how the clients may implement work for the use cases may also be based on the duration for implementing the use case.

The current profile predictor module 314 may retrieve current profiles for the work the clients may implement or how the clients may implement work for the use cases from memory 302, 306. Some or all of the work may be broken down into common or repeated types of work and manners of implementing the work for the clients. Current profiles for the common or repeated types of work and manners of implementing the work for the clients may be stored in memory 302, 306. Based on the common or repeated types of work and manners of implementing the work for the use cases for the clients, the current profile predictor module 314 may retrieve the corresponding current profiles. The current profile predictor module 314 may interpret the retrieved current profiles for the common or repeated types of work and manners of implementing the work for the use cases for the clients to implement one or more algorithms, heuristics, or other calculation or decision-making processes to identify potential current profiles for use cases of the clients.

In some embodiments, the current profile predictor module 314 may be configured to retrieve the current profiles for the use cases for the clients from memory 302, 306. For example, current profiles for what work the clients may implement or how the clients may implement work for the entirety of the use cases may be stored in memory 302, 306. Based on the use cases, the current profile predictor module 314 may retrieve current profiles for the clients from the memory 302, 306.

The current profile predictor module 314 may be configured to identify a potential maximum current for the use case for the client from the retrieved current profile(s). In some embodiments, the current profile predictor module 314 may identify potential maximum currents for the use cases for the clients from the retrieved current profiles for the common or repeated types of work and manners of implementing the work for the clients from memory 302, 306. In some embodiments, the current profile predictor module 314 may identify potential maximum currents for the use cases for the clients from the current profiles for the use cases for the clients retrieved from the memory 302, 306. For example, the current profile predictor module 314 may be configured to implement one or more algorithms, heuristics, or other calculation or decision-making processes to identify potential maximum currents from the current profiles for the use cases for the clients. In some embodiments, the retrieved current profile(s) may include information configured to indicate to the current profile predictor module 314 dynamic current usage over a duration. The current profile predictor module 314 may base identifying potential maximum currents from the current profiles for the use cases for the clients on the dynamic current usage over a duration. As another example, the current profile predictor module 314 may be configured to parse potential maximum currents from the current profiles for the use cases for the clients.

The current profile predictor module 314 may be configured to identify the potential current profile for the use case for the client based on the maximum current for the client and the potential maximum current for the use case for the client. The current profile predictor module 314 may be configured to implement one or more algorithms, heuristics, or other calculation or decision-making processes to identify potential current profiles for the use cases for the clients based on the maximum currents for the clients and the potential maximum currents for the use cases for the clients. For example, the current profile predictor module 314 may compare the maximum currents for the clients and the potential maximum currents for the use cases for the clients to identify a difference between the maximum currents for the clients and the potential maximum currents for the use cases for the clients.

A dynamic voltage reduction module 316 may be configured to identify a voltage reduction for the use case for the client based in part on the potential current profile for the use case for the client. Voltage reductions for the use cases for the clients may be configured to indicate to the processor system 304 or the system power manager to reduce voltages to the clients to voltage levels. The voltage levels may be configured to maintain the voltages to the clients at greater levels than minimum voltages for the clients during occurrences of voltage droop corresponding to the potential maximum currents for the use cases for the clients. In some embodiments, the voltage reductions may be values configured to indicate to the system power manager voltage levels to which to reduce the voltages to the clients for the use cases. In some embodiments, the voltage reductions may be values configured to indicate to the system power manager amounts of voltage by which to reduce the voltages to the clients for the use cases. The dynamic voltage reduction module 316 may be configured to implement one or more algorithms, heuristics, or other calculation or decision-making processes to identify voltage reductions for the use cases for the clients based on the potential current profiles for the use cases for the clients. For example, the voltage reductions may be functions of the potential current profiles for the use cases for the clients and the peak impedances of the clients.

A dynamic voltage reduction communication module 318 may be configured to transmit the voltage reduction for the use case of the client to the system power manager. Transmitting the voltage reductions for the use cases of the clients to the system power manager may include formatting or encoding, generating, and sending signals configured to at least indicate to the system power manager the voltage reductions for the use cases of the clients. In some embodiments, the signals may be further configured to prompt the system power manager to reduce voltages to the clients for the use cases based on the voltage reductions for the use cases of the clients.

In some embodiments, the client may be the processor system 304 implementing one or more modules 310-318. In some embodiments, the client may be a component of the processor system 304 implementing the one or more modules 310-318, such as a core or an integrated circuit of the processor system 304. In some embodiments, the client may be a component of a subsystem to which the processor system 304 implementing the one or more modules 310-318 belongs, such as another processor system of the subsystem, a component of the another processor system of the subsystem, or an integrated circuit of the subsystem.

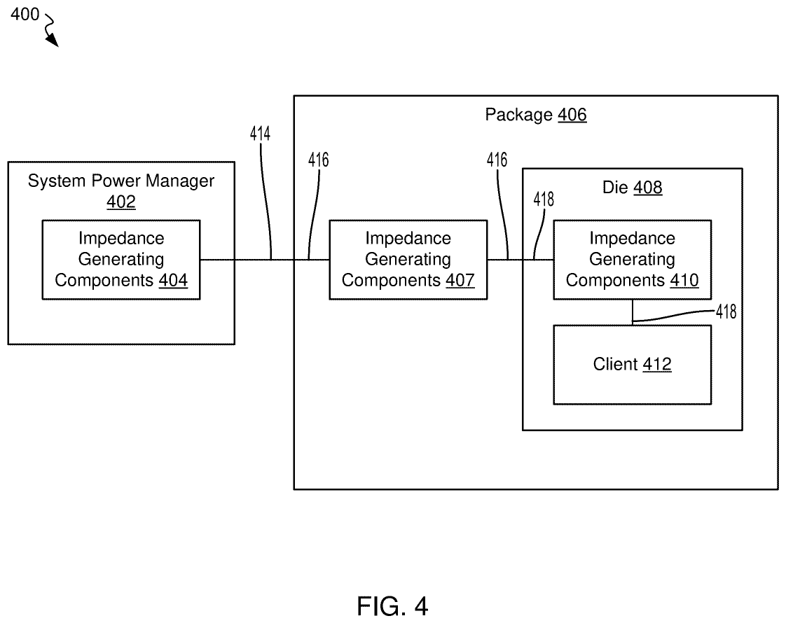

FIG. 4 illustrates an example power management system 400 configured for implementing dynamic voltage adjustment for a client 412 of a computing device (e.g., computing device 10, 300 in FIGS. 1 and 3) for implementing various embodiments. With reference to FIGS. 1-4, the power management system 400 may include a system power manager 402 (e.g., power manager 28, in FIG. 1) electrically connected to at least one computing component package 406 via at least one electrical bus 414. A package 406 may further include at least one die 408 electrically connected to the system power manager 402 via the electrical bus 414. A die 408 may be connected to the electrical bus 414 via an electrical connector 416. In some embodiments, the electrical connector 416 may be integral to the package 406. The die 408 may further include at least one client 412 (e.g., processor system 14, memory 16, communication interface 18, storage memory interface 20, memory interface 34, peripheral device interface 38, communication component 22, storage memory 24, memory 36, peripheral device 40 in FIG. 1, subsystems 202, 204, 206, 208, 210, 212, 214 in FIG. 2) connected to the system power manager 402 via the electrical bus 414. A client 412 may be electrically connected to the electrical bus 414 via an electrical connector 418 and the electrical connector 416. The electrical connector 418 may be integral to the die 408.

Some or all the components of the power management system 400 may be integral to an SoC (e.g., SoC 12 in FIGS. 1 and 2), such as the system power manager 402. In some embodiments, some or all the components of the power management system 400 may be integral to a subsystem (e.g., peripheral device 40 in FIG. 1, subsystems 202, 204, 206, 208, 210, 212, 214 in FIG. 2), such as the package 406, the die 408, and the client 412.

The system power manager 402 may be configured to control power states of one or more electrical buses 414 or connectors 416, 418, for power delivery to the package 406, the die 408, and the client 412. In some embodiments, the system power manager 402 may be configured to control the amounts of power provided to the package 406, the die 408, and the client 412. For example, the system power manager 402 may be configured to control connections between the package 406, the die 408, and the client 412 and the electrical buses 414 or connectors 416, 418. As another example, the system power manager 402 may be configured to control amounts of power on the electrical buses 414 or connectors 416, 418 connected to the package 406, the die 408, and the client 412. The system power manager 402 may be configured as a power management integrated circuit (power management ICs or PMIC). The system power manager 402 may include various components configured to enable the system power manager 402 to control the power states of one or more electrical buses 414 or connectors 416, 418, for power delivery to the package 406, the die 408, and the client 412. The components of the system power manager 402 may have properties that cause impedance in a circuit connecting the system power manager 402 and the package 406, referred to herein as impedance-generating components 404.

The package 406 may include one or more interconnected components, such as printed circuit boards, chips, dies 408, and various components configured to enable the package 406 to control power delivery to the one or more interconnected components. The components of the package 406 may have properties that cause impedance in a circuit connecting the system power manager 402 and the die 408, referred to herein as impedance-generating components 407. The die 408 may include an integrated circuit configured to implement the client 412 and various components configured to enable the die 408 to control power delivery to the client 412. The components of the die 408 may have properties that cause impedance in a circuit connecting the system power manager 402 and the client 412, referred to herein as impedance-generating components 410.

The system power manager 402 may be configured to provide a voltage to the client 412 in the power management system 400. The voltage provided as an output from the system power manager 402 to the client 412 may not be the same as the voltage available to the client 412 from the system power manager 402 due to impedance in the power management system 400 caused by the impedance generating components 404, 407, and 410. The impedance in the power management system 400 may also vary depending on the current drawn from the power management system 400 by the client. Increasing impedance in the power management system 400 may cause a corresponding voltage droop. Typically, the system power manager 402 may maintain a voltage level in the power management system 400 to avoid a worst-case scenario voltage droop, lowering the voltage of the power management system 400 to below a minimum voltage for the client 412. The voltage level may be greater than the voltage needed for the client 412 in many circumstances.

The client 412 may be configured to implement various functions (e.g., functions of the one or more modules 310-318 in FIG. 3) to identify voltage reduction for the use case for the client 412 based in part on the potential current profile for the use case for the client 412. The client may also transmit the voltage reduction for the use case for the client 412 to the system power manager 402. The system power manager 402 may adjust the voltage output to the client 412 based on the voltage reduction for the use case for the client 412 received from the client.

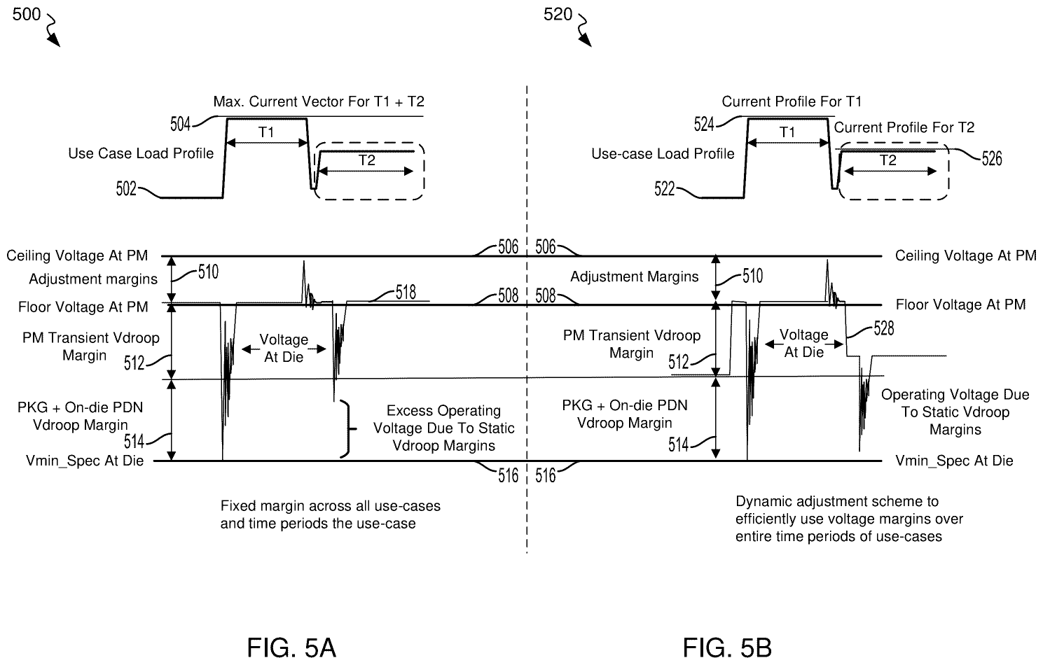

FIGS. 5A and 5B illustrate an example of dynamic voltage adjustment for a client of a computing device (e.g., computing device 10, 300 in FIGS. 1 and 3) in accordance with various embodiments. With reference to FIGS. 1-5B, a timing diagram 500 may illustrate power management for the client (e.g., processor system 14, memory 16, communication interface 18, storage memory interface 20, memory interface 34, peripheral device interface 38, communication component 22, storage memory 24, memory 36, peripheral device 40 in FIG. 1, subsystems 202, 204, 206, 208, 210, 212, 214 in FIG. 2, client 412 in FIG. 4) prior to dynamic voltage adjustment. A timing diagram 520 may illustrate power management for the client implementing dynamic voltage adjustment.

In the timing diagrams 500, 520 are illustrated several like aspects, including a ceiling voltage at a system power manager (“PM”) 506, a floor voltage at the system power manager (“PM”) 508, an adjustment margin 510, a system power manager (“PM”) transient voltage droop (“Vdroop”) margin 512, a package (“PKG”) and (“+”) on-die power deliver network (“PDN”) voltage droop (“Vdroop”) margin 514, and a minimum voltage specification

(“Vmin_Spec”) at die 516. The ceiling voltage at a system power manager 506 may be the maximum amount of voltage a system power manager (e.g., power manager 28, in FIG. 1, system power manager 402 in FIG. 4) may output to the client. The floor voltage at the system power manager 508 may be the minimum amount of voltage the system power manager may output to the client without implementing dynamic power adjustment for the client. The system power manager transient voltage droop margin 512 may be an amount of voltage droop expected to be caused by the impedance of the system power manager (including impedance generating components 404 in FIG. 4) for a worst-case scenario voltage droop. The package and on-die power deliver network voltage droop margin 514 may be an amount of voltage droop expected to be caused by the impedance of a package (e.g., package 406 in FIG. 4; including impedance generating components 407 in FIG. 4) and die (e.g., die 408 in FIG. 4; including impedance generating components 410 in FIG. 4) for a worst-case scenario voltage droop. The minimum voltage specification at die 516 may be a minimum amount of voltage received by the die to enable proper function of the die.

The timing diagram 500 may include a use case load profile 502 for the use case for multiple durations (e.g., “T1,” “T2”), which may be expressed in various units, including time. The timing diagram 500 may include a maximum (“max.”) current vector for the multiple duration (“T1+T2”) 504. As illustrated in the timing diagram 500, the use case load profile 502 may have varying load requirements at duration T1 and T2, with the load requirement at duration T1 being greater than the load requirement at duration T2. Without implementing dynamic voltage adjustment, the maximum current vector for the multiple duration 504 may remain static and approximately the same as the load requirement at duration T1.

A voltage at the die 518 is similarly illustrated in the timing diagram 500 for the multiple durations. The voltage at the die 518 remains at the same level, approximately the same as the floor voltage at the system power manager 508, in response to no transient currents for a power delivery network (e.g., power management system 400 in FIG. 4) for the client. The lack of transient currents may correspond with high and low signals of the use case load profile 502. In response to transient currents for the power delivery network for the client, voltage droop occurs, reducing the voltage at the die 518 below the floor voltage at the system power manager 508. The transient currents may correspond with rising and falling signals of the use case load profile 502. In the timing diagram 500, it is illustrated that for the lesser load requirement at duration T2, the transient current may be such that the voltage droop is not so severe as to reduce the voltage at the die 518 to approximately the minimum voltage specification at die 516. The voltage margin between the voltage at the die 518 and the minimum voltage specification at die 516 during for the transient current for the lesser load requirement at duration T2 may be wasted.

The timing diagram 520 may include a use case load profile 522 for the use case for multiple durations (e.g., “T1,” “T2”), which may be expressed in various units, including time. The use case load profile 522 may be the same, similar, or different from the use case load profile 502. The timing diagram 520 may include current profiles for the multiple durations, including the current profile for T1 524 for duration T1 and the current profile for T2 526 for duration T2. As illustrated in the timing diagram 520, the use case load profile 502 may have varying load requirements at duration T1 and T2, with the load requirement at duration T1 being greater than the load requirement at duration T2. Implementing dynamic voltage adjustment, the current profiles for the multiple durations 524, 526 may vary in a corresponding manner to the use case load profile 502, with the current profile for T1 524 being greater than the current profile for T2 526.

A voltage at the die 528 is similarly illustrated in the timing diagram 520 for the multiple durations. The voltage at the die 528 varies in response to no transient currents for a power delivery network (e.g., power management system 400 in FIG. 4) for the client. The voltage at the die 528 may vary in accordance with the current profiles for the multiple durations 524, 526 and the system power manager adjusting the voltage output to the die according to dynamic voltage adjustment. The lack of transient currents may correspond with high and low signals of the use case load profile 522. In response to transient currents for the power delivery network for the client, voltage droop occurs, reducing the voltage at the die 528 below the level of the voltage at the die 528 in response to no transient currents for a power delivery network for the client. The transient currents may correspond with rising and falling signals of the use case load profile 522. In the timing diagram 520, it is illustrated that for the lesser current profile for T2 526, the transient current may be such that the voltage droop may be sufficiently severe to reduce the voltage at the die 528 to approximately the minimum voltage specification at die 516. As compared to the voltage at the die 518, for the lesser load requirement at duration T2 in the timing diagram 500, there is a voltage margin between the voltage at the die 528 and the minimum voltage specification at die 516. This less voltage margin between the voltage at the die 528 and the minimum voltage specification at die 516 during for the transient current for the lesser load requirement at duration T2 shows that the voltage at the die 528 is tailored to the use case for the client reducing wasted voltage.

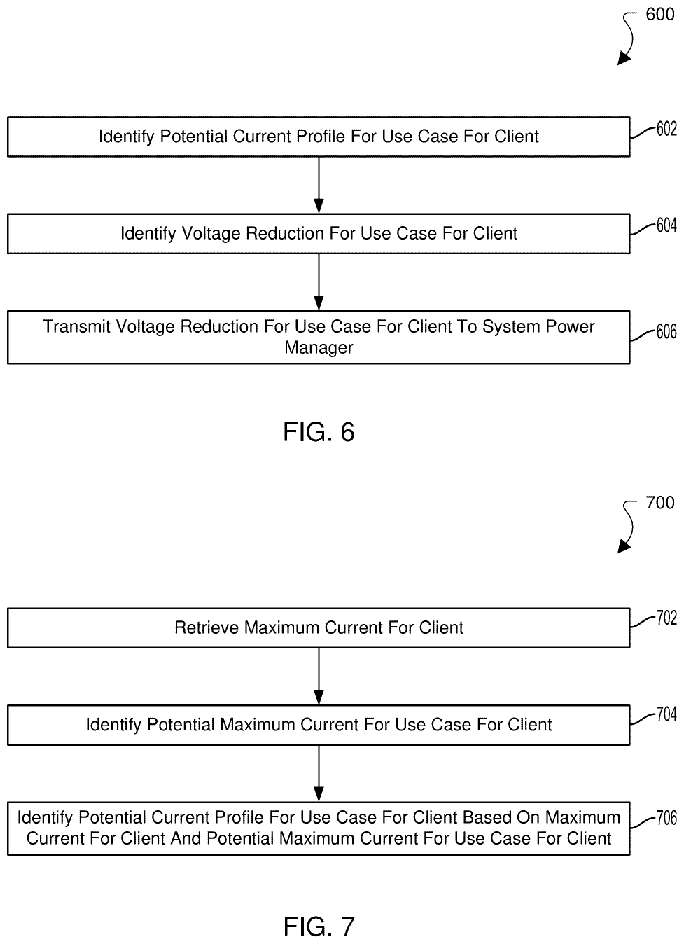

FIG. 6 illustrates an example method for dynamic voltage adjustment for a client of a computing device according to an embodiment. With reference to FIGS. 1-6, the method 600 may be implemented in a computing device (e.g., computing device 10, 300 in FIGS. 1 and 3), in hardware (e.g., modules 310-318 in FIGS. 3, client 412 in FIG. 4), in software (e.g., modules 310-318 in FIGS. 3, client 412 in FIG. 4) executing in a processor system (e.g., processor system 14, 210, 304 in FIGS. 1-3, client 412 in FIG. 4), or in a combination of a software-configured processor and dedicated hardware, that includes other individual components, such as various memories/caches (e.g., memory 16, 36, 302, 306 in FIGS. 1 and 3). In order to encompass the alternative configurations enabled in various embodiments, the hardware implementing the method 600 is referred to herein as a “client device.”

In block 602, the client device may identify a potential current profile for a use case for a client (e.g., processor system 14, memory 16, communication interface 18, storage memory interface 20, memory interface 34, peripheral device interface 38, communication component 22, storage memory 24, memory 36, peripheral device 40 in FIG. 1, subsystems 202, 204, 206, 208, 210, 212, 214 in FIG. 2, client 412 in FIG. 4). The client device may identify the potential current profile for the use case for the client as described for the method 700 with reference to FIG. 7. In some embodiments, the client device identifying the potential current profile for the use case for the client in block 602 may include a processor system (e.g., processor system 14, 210, 304 in FIGS. 1-3), a maximum current module (e.g., maximum current module 310 in FIG. 3), a current profile predictor module (e.g., current profile predictor module 314 in FIG. 3), or a client (e.g., client 412 FIG. 4).

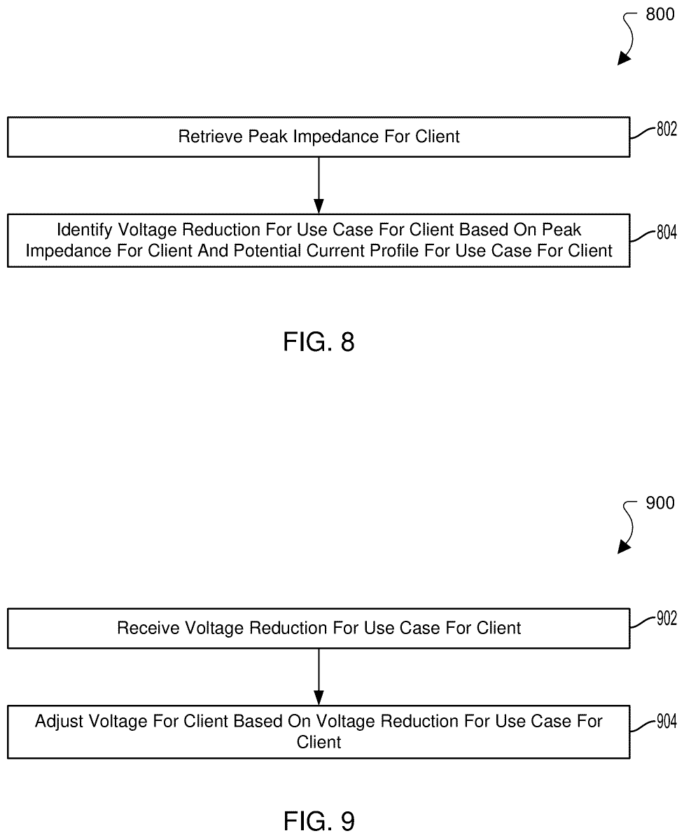

In block 604, the client device may identify a voltage reduction for the use case for the client based in part on the potential current profile for the use case for the client. The client device may identify the voltage reduction for the use case for the client based in part on the potential current profile for the use case for the client as described for the method 800 with reference to FIG. 8. In some embodiments, the client device identifying the voltage reduction for the use case for the client based in part on the potential current profile for the use case for the client in block 604 may include the processor system, a peak impedance module (e.g., peak impedance module 312 in FIG. 3), a voltage reduction module (e.g., voltage reduction module 316 in FIG. 3), or the client.

In block 606, the client device may transmit the voltage reduction for the use case for the client to a system power manager (e.g., power manager 28, in FIG. 1, system power manager 402 in FIG. 4). Transmitting the voltage reduction for the use case of the client to the system power manager may include formatting or encoding, generating, and sending a signal configured to at least indicate to the system power manager the voltage reduction for the use case of the client. In some embodiments, the signals may be further configured to prompt the system power manager to reduce voltages to the clients for the uses cases based on the voltage reductions for the use cases of the clients. In some embodiments, the client device transmitting the voltage reduction for the use case for the client to a system power manager in block 606 may include the processor system, a voltage reduction module (e.g., voltage reduction module 316 in FIG. 3), or the client.

FIG. 7 illustrates an example method for identifying a potential current profile for a use case at a client according to an embodiment. With reference to FIGS. 1-7, the method 700 may be implemented in a computing device (e.g., computing device 10, 300 in FIGS. 1 and 3), in hardware (e.g., modules 310-318 in FIGS. 3, client 412 in FIG. 4), in software (e.g., modules 310-318 in FIGS. 3, client 412 in FIG. 4) executing in a processor system (e.g., processor system 14, 210, 304 in FIGS. 1-3, client 412 in FIG. 4), or in a combination of a software-configured processor and dedicated hardware, that includes other individual components, such as various memories/caches (e.g., memory 16, 36, 302, 306 in FIGS. 1 and 3). In order to encompass the alternative configurations enabled in various embodiments, the hardware implementing the method 700 is referred to herein as a “client device.”

In block 702, the client device may retrieve a maximum current for a client (e.g., processor system 14, memory 16, communication interface 18, storage memory interface 20, memory interface 34, peripheral device interface 38, communication component 22, storage memory 24, memory 36, peripheral device 40 in FIG. 1, subsystems 202, 204, 206, 208, 210, 212, 214 in FIG. 2, client 412 in FIG. 4) from a memory (e.g., memory 16, 36, 302, 306 in FIGS. 1 and 3). The maximum current may be a value configured to represent to the client device a maximum amount of current required by the client. In some embodiments, the client device retrieving the maximum current for the client from memory in block 702 may include a processor system (e.g., processor system 14, 210, 304 in FIGS. 1-3), a maximum current module (e.g., maximum current module 310 in FIG. 3), or a client (e.g., client 412 FIG. 4).

In block 704, the client device may identify a potential maximum current for a use case for the client. In some embodiments, the client device identifying the potential maximum current for the use case for the client in block 704 may include the processor system, a current profile predictor module (e.g., current profile predictor module 314 in FIG. 3), or the client.

In some embodiments, the use case may be based on work pending for the client, such as in a scheduler queue, states of the computing device or the client that may trigger certain work, etc. In some embodiments, the client device may identify what work the client may implement or how the client may implement work for the use case, such as based on workloads, instruction sets, frequencies, or operations (e.g., a shader calculation in a GPU) for the use case.

In some embodiments, the client device may retrieve current profiles for the work the client device may implement or how the client device may implement work for the use case from memory. Some or all the work may be broken down into common or repeated types of work and manners of implementing the work for the client. Current profiles for the common or repeated types of work and manners of implementing the work for the client may be stored in the memory. Based on the common or repeated types of work and manners of implementing the work for the use case for the client, the client device may retrieve the corresponding current profiles.

In some embodiments, the client device may be configured to retrieve the current profile for the use case for the client from the memory. For example, the current profile for what work the client device may implement or how the client device may implement work for the entirety of the use case may be stored in the memory. Based on the use case, the client device may retrieve the current profile for the client from the memory.

The client device may be configured to identify the potential maximum current for the use case for the client from the current profile(s) retrieved from the memory. In some embodiments, the client device may identify the potential maximum current for the use case for the client from the retrieved current profiles for the common or repeated types of work and manners of implementing the work for the client from memory. In some embodiments, the client device may identify the potential maximum current for the use case for the client from the current profile for the use case for the client retrieved from the memory. For example, the client device may be configured to implement one or more algorithms, heuristics, or other calculation or decision-making processes to identify the potential maximum current from the retrieved current profile(s). In some embodiments, the retrieved current profile(s) may include information configured to indicate to the client device dynamic current usage over a duration. The client device may base identifying potential maximum currents from the current profiles for the use cases for the clients on the dynamic current usage over a duration. As another example, the client device may be configured to parse the potential maximum current from the retrieved current profile(s).

In block 706, the client device may identify the potential current profile for the use case for the client based on the maximum current for the client and the potential maximum current for the use case for the client. The client device may be configured to implement one or more algorithms, heuristics, or other calculation or decision-making processes to identify the potential current profile for the use case for the client based on the maximum current for the client and the potential maximum current for the use case for the client. For example, the client device may compare the maximum current for the client and the potential maximum current for the use case for the client to identify a difference between the maximum current for the client and the potential maximum current for the use case for the client. In some embodiments, the client device identifying the potential current profile for the use case for the client based on the maximum current for the client and the potential maximum current for the use case for the client in block 706 may include the processor system, the current profile predictor module, or the client.

FIG. 8 illustrates an example method for identifying a voltage reduction for a use case at a client according to an embodiment. With reference to FIGS. 1-8, the method 800 may be implemented in a computing device (e.g., computing device 10, 300 in FIGS. 1 and 3), in hardware (e.g., modules 310-318 in FIGS. 3, client 412 in FIG. 4), in software (e.g., modules 310-318 in FIGS. 3, client 412 in FIG. 4) executing in a processor system (e.g., processor system 14, 210, 304 in FIGS. 1-3, client 412 in FIG. 4), or in a combination of a software-configured processor and dedicated hardware, that includes other individual components, such as various memories/caches (e.g., memory 16, 36, 302, 306 in FIGS. 1 and 3). In order to encompass the alternative configurations enabled in various embodiments, the hardware implementing the method 800 is referred to herein as a “client device.”

In block 802, the client device may retrieve a peak impedance for the client (e.g., processor system 14, memory 16, communication interface 18, storage memory interface 20, memory interface 34, peripheral device interface 38, communication component 22, storage memory 24, memory 36, peripheral device 40 in FIG. 1, subsystems 202, 204, 206, 208, 210, 212, 214 in FIG. 2, client 412 in FIG. 4) from a memory (e.g., memory 16, 36, 302, 306 in FIGS. 1 and 3). The client device may be configured to identify a peak impedance to the client based on a frequency of current to the client. The peak impedance may be values configured to represent to the client device the greatest amounts of impedance between the system power manager (e.g., power manager 28, in FIG. 1, system power manager 402 in FIG. 4) and the client. In some embodiments, the client device retrieving the peak impedance for the client from memory in block 802 may include a processor system (e.g., processor system 14, 210, 304 in FIGS. 1-3), a peak impedance module (e.g., peak impedance module 312 in FIG. 3), or a client (e.g., client 412 FIG. 4).

In block 804, the client device may identify a voltage reduction for the use case for the client based on the potential current profile for the use case for the client and the peak impedance for the client. The voltage reductions for the use cases for the client may be configured to indicate to the client device or the system power manager to reduce voltage to the client to a voltage level. The voltage level may be configured to maintain the voltage to the client at a level greater than a minimum voltage for the client during occurrences of voltage droop corresponding to the potential maximum current for the use case for the client. In some embodiments, the voltage reduction may be values configured to indicate to the system power manager a voltage level to which to reduce the voltage to the client for the use case. In some embodiments, the voltage reduction may be values configured to indicate to the system power manager an amount of voltage by which to reduce the voltage to the client for the use case. The client device may be configured to implement one or more algorithms, heuristics, or other calculation or decision-making processes to identify the voltage reduction for the use case for the client based on the potential current profile for the use cases for the client. For example, the voltage reduction may be a function of the potential current profile for the use case for the client and the peak impedance of the client. In some embodiments, the client device identifying the voltage reduction for the use case for the client based on the potential current profile for the use case for the client and the peak impedance for the client in block 804 may include the processor system, a dynamic voltage reduction module (e.g., dynamic voltage reduction module 316 in FIG. 3), or the client.

FIG. 9 illustrates an example method for dynamic voltage adjustment for a client of a computing device according to an embodiment. With reference to FIGS. 1-9, the method 900 may be implemented in a computing device (e.g., computing device 10, 300 in FIGS. 1 and 3), in hardware (e.g., power manager 28, in FIG. 1, system power manager 402 in FIG. 4), in software executing in a processor system (e.g., processor system 14, 210, 304 in FIGS. 1-3), or in a combination of a software-configured processor and dedicated hardware, that includes other individual components, such as various memories/caches (e.g., memory 16, 36, 302, 306 in FIGS. 1 and 3). In order to encompass the alternative configurations enabled in various embodiments, the hardware implementing the method 800 is referred to herein as a “power management device.”

In block 902, the power management device may receive a voltage reduction for a use case for a client (e.g., processor system 14, memory 16, communication interface 18, storage memory interface 20, memory interface 34, peripheral device interface 38, communication component 22, storage memory 24, memory 36, peripheral device 40 in FIG. 1, subsystems 202, 204, 206, 208, 210, 212, 214 in FIG. 2, client 412 in FIG. 4). The voltage reduction for the use case for the client may be as transmitted to the system power manager in block 606 of the method 600 described with reference to FIG. 6. In some embodiments, the power management device receiving the voltage reduction for the use case for the client in block 904 may include a system power manager (e.g., power manager 28, in FIG. 1, system power manager 402 in FIG. 4).

In block 904, the power management device may adjust a voltage for the client based on the voltage reduction for the use case for the client. The power management device may interpret the voltage reduction for the use case for the client and reduce a voltage output of a system power manager (e.g., power manager 28, in FIG. 1, system power manager 402 in FIG. 4) to the client accordingly. In some embodiments, the power management device may reduce the voltage to the client to a level indicated by the voltage reduction for the use case for the client. In some embodiments, the power management device may reduce the voltage to the client by a voltage amount indicated by the voltage reduction for the use case for the client. In some embodiments, the power management device adjusting the voltage for the client based on the voltage reduction for the use case the for client in block 904 may include the system power manager.

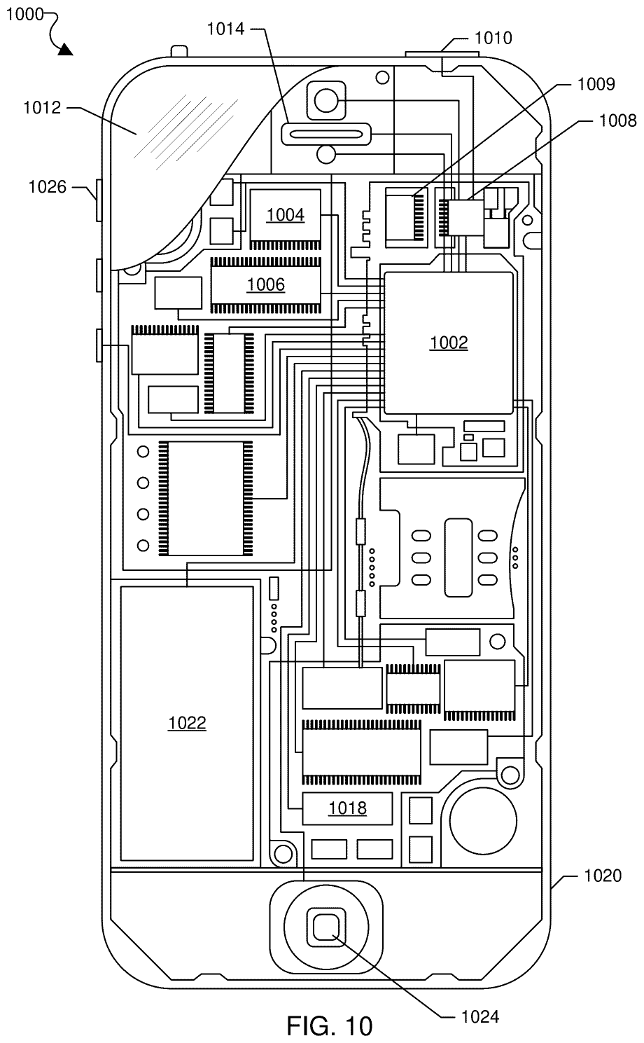

A system in accordance with the various embodiments (including, but not limited to, embodiments described above with reference to FIGS. 1-9) may be implemented in a wide variety of computing systems, including mobile computing devices, an example of which suitable for use with the various embodiments is illustrated in FIG. 10. The mobile computing device 1000 may include a processor 1002 coupled to a touchscreen controller 1004 and an internal memory 1006. The processor 1002 may be one or more multicore integrated circuits designated for general or specific processing tasks. The internal memory 1006 may be a volatile or non-volatile memory and may also be secure and/or encrypted memory, unsecured and/or unencrypted memory, or any combination thereof. Examples of memory types that can be leveraged include but are not limited to DDR, Low-Power DDR (LPDDR), Graphics DDR (GDDR), WIDEIO, RAM, Static RAM (SRAM), Dynamic RAM (DRAM), Parameter RAM (P-RAM), Resistive RAM (R-RAM), Magnetoresistive RAM (M-RAM), Spin-Transfer Torque RAM (STT-RAM), and embedded DRAM. The touchscreen controller 1004 and the processor 1002 may also be coupled to a touchscreen panel 1012, such as a resistive-sensing touchscreen, capacitive-sensing touchscreen, infrared-sensing touchscreen, etc. Additionally, the display of the mobile computing device 1000 need not have touchscreen capability.

The mobile computing device 1000 may have one or more radio signal transceivers 1008 (e.g., Peanut, Bluetooth, ZigBee, Wi-Fi, RF radio) and antennae 1010, for sending and receiving communications, coupled to each other and/or to the processor 1002. The processor 1002 may also be coupled to a cellular network wireless modem 1009 that enables communication via a cellular network (e.g., a 5G network) via the antenna 1010. The transceivers 1008 and antennae 1010 may be used with the above-mentioned circuitry to implement the various wireless transmission protocol stacks and interfaces.

The mobile computing device 1000 may include a peripheral device connection interface 1018 coupled to the processor 1002. The peripheral device connection interface 1018 may be singularly configured to accept one type of connection or may be configured to accept various types of physical and communication connections, common or proprietary, such as Universal Serial Bus (USB), FireWire, Thunderbolt, or PCIe. The peripheral device connection interface 1018 may also be coupled to a similarly configured peripheral device connection port (not shown).

The mobile computing device 1000 may also include speakers 1014 for providing audio outputs. The mobile computing device 1000 may also include a housing 1020, constructed of plastic, metal, or a combination of materials, for containing all or some of the components described herein. The mobile computing device 1000 may include a power source 1022 coupled to the processor 1002, such as a disposable or rechargeable battery. The rechargeable battery may also be coupled to the peripheral device connection port to receive a charging current from a source external to the mobile computing device 1000. The mobile computing device 1000 may also include a physical button 1024 for receiving user inputs. The mobile computing device 1000 may also include a power button 1026 for turning the mobile computing device 1000 on and off.

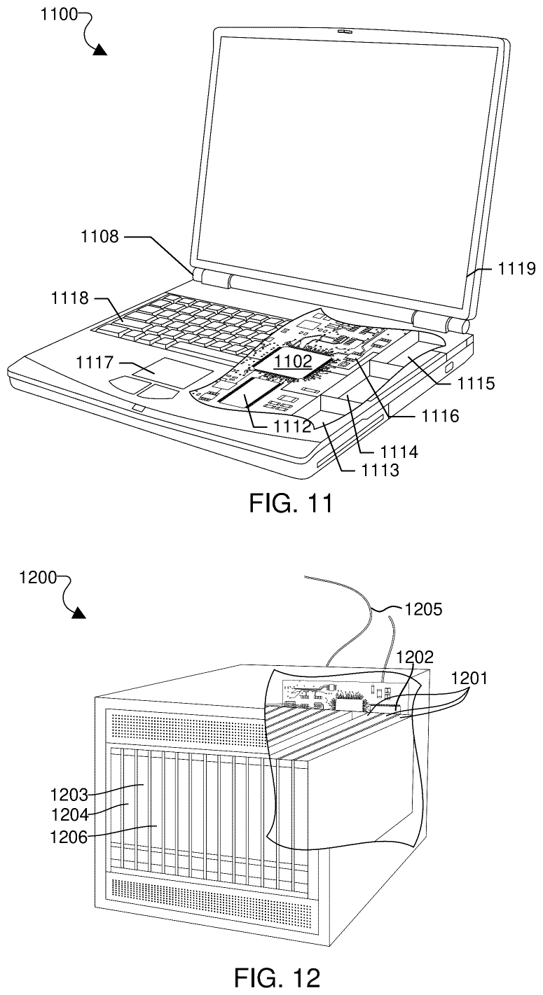

A system in accordance with the various embodiments (including, but not limited to, embodiments described above with reference to FIGS. 1-9) may be implemented in a wide variety of computing systems, including a laptop computer 1100, an example of which is illustrated in FIG. 11. Many laptop computers include a touchpad touch surface 1117 that serves as the computer's pointing device and thus may receive drag, scroll, and flick gestures similar to those implemented on computing devices equipped with a touch screen display and described above. A laptop computer 1100 will typically include a processor 1102 coupled to volatile memory 1112 and a large capacity nonvolatile memory, such as a disk drive 1113 of Flash memory. Additionally, the computer 1100 may have one or more antenna 1108 for sending and receiving electromagnetic radiation that may be connected to a wireless data link and/or cellular telephone transceiver 1116 coupled to the processor 1102. The computer 1100 may also include a floppy disc drive 1114 and a compact disc (CD) drive 1115 coupled to the processor 1102. In a notebook configuration, the computer housing includes the touchpad 1117, the keyboard 1118, and the display 1119 all coupled to the processor 1102. Other configurations of the computing device may include a computer mouse or trackball coupled to the processor (e.g., via a USB input) as are well known, which may also be used in conjunction with the various embodiments.

A system in accordance with the various embodiments (including, but not limited to, embodiments described above with reference to FIGS. 1-9) may also be implemented in fixed computing systems, such as any of a variety of commercially available servers. An example server 1200 is illustrated in FIG. 12. Such a server 1200 typically includes one or more multicore processor assemblies 1201 coupled to volatile memory 1202 and a large capacity nonvolatile memory, such as a disk drive 1204. As illustrated in FIG. 12, multicore processor assemblies 1201 may be added to the server 1200 by inserting them into the racks of the assembly. The server 1200 may also include a floppy disc drive, compact disc (CD) or digital versatile disc (DVD) disc drive 1206 coupled to the processor 1201. The server 1200 may also include network access ports 1203 coupled to the multicore processor assemblies 1201 for establishing network interface connections with a network 1205, such as a local area network coupled to other broadcast system computers and servers, the Internet, the public switched telephone network, and/or a cellular data network (e.g., CDMA, TDMA, GSM, PCS, 3G, 4G, LTE, 5G or any other type of cellular data network).

Implementation examples are described in the following paragraphs. While some of the following implementation examples are described in terms of example systems, devices, or methods, further example implementations may include the example systems or devices discussed in the following paragraphs implemented as a non-transitory processor-readable storage medium having stored thereon processor-executable instructions configured to cause a processor of a computing device to perform the operations of the example systems, devices, or methods.

Example 1. A method performed by a processor system of a computing device for dynamic voltage adjustment for a client of the computing device, including: identifying a potential current profile for a use case for the client; identifying a voltage reduction for the use case for the client based in part on the potential current profile for the use case for the client; and transmitting the voltage reduction for the use case for the client to a system power manager.

Example 2. The method of example 1, in which identifying the potential current profile for the use case for the client includes: retrieving a maximum current for the client from a memory; identifying a potential maximum current for the use case for the client; and identifying the potential current profile for the use case for the client based on the maximum current for the client and the potential maximum current for the use case for the client.

Example 3. The method of example 2, in which the voltage reduction for the use case for the client is configured to indicate to the system power manager to reduce a voltage to the client to a voltage level that maintains the voltage to the client at a level greater than a minimum voltage for the client during an occurrence of voltage droop corresponding to the potential maximum current for the use case for the client.

Example 4. The method of any of examples 2-3, in which identifying the potential maximum current for the use case for the client includes calculating the potential maximum current for the use case for the client based on pending work for the use case for the client.

Example 5. The method of any of examples 2-, in which identifying the potential maximum current for the use case for the client includes retrieving the potential maximum current for the use case for the client from the memory.

Example 6. The method of any of examples 1-5, in which identifying the voltage reduction for the use case for the client based in part on the potential current profile for the use case for the client includes: retrieving a peak impedance for the client from a memory; and identifying the voltage reduction for the use case for the client based on the potential current profile for the use case for the client and the peak impedance for the client.

Computer program code or “program code” for execution on a programmable processor for carrying out operations of the various embodiments may be written in a high-level programming language such as C, C++, C#, Smalltalk, Java, JavaScript, Visual Basic, a Structured Query Language (e.g., Transact-SQL), Perl, or in various other programming languages. References to program code or programs stored on a computer-readable storage medium in this application may include machine language code (such as object code) whose format is understandable by a processor.

The foregoing method descriptions and the process flow diagrams are provided merely as illustrative examples and are not intended to require or imply that the operations of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are simply used to guide the reader through the description of the methods. Further, any reference to claim elements in the singular, for example, using the articles “a,” “an,” or “the,” is not to be construed as limiting the element to the singular.

The various illustrative logical blocks, modules, circuits, and algorithm operations described in connection with the various embodiments may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the embodiments disclosed herein may be implemented or performed with a general-purpose processor, a digital signal processor (DSP), an application-specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more embodiments, the functions described may be implemented in hardware, software, firmware, or any combination thereof. If implemented in software, the functions may be stored as one or more instructions or code on a non-transitory computer-readable medium or a non-transitory processor-readable medium. The operations of a method or algorithm disclosed herein may be embodied in a processor-executable software module that may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, include compact disc (CD), laser disc, optical disc, digital versatile disc (DVD), floppy disc, and Blu- ray disc, where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments and implementations without departing from the scope of the claims. Thus, the present disclosure is not intended to be limited to the embodiments and implementations described herein, but is to be accorded the widest scope consistent with the following claims and the principles and novel features disclosed herein.

What is claimed is:

1. A method performed by a processor system of a computing device for dynamic voltage adjustment for a client of the computing device, comprising:
identifying a potential current profile for a use case for the client;
identifying a voltage reduction for the use case for the client based in part on the potential current profile for the use case for the client; and
transmitting the voltage reduction for the use case for the client to a system power manager.

2. The method of claim 1, wherein identifying the potential current profile for the use case for the client comprises:
retrieving a maximum current for the client from a memory;
identifying a potential maximum current for the use case for the client; and
identifying the potential current profile for the use case for the client based on the maximum current for the client and the potential maximum current for the use case for the client.

3. The method of claim 2, wherein the voltage reduction for the use case for the client is configured to indicate to the system power manager to reduce a voltage to the client to a voltage level that maintains the voltage to the client at a level greater than a minimum voltage for the client during an occurrence of voltage droop corresponding to the potential maximum current for the use case for the client.

4. The method of claim 2, wherein identifying the potential maximum current for the use case for the client comprises calculating the potential maximum current for the use case for the client based on pending work for the use case for the client.

5. The method of claim 2, wherein identifying the potential maximum current for the use case for the client comprises retrieving the potential maximum current for the use case for the client from the memory.

6. The method of claim 1, wherein identifying the voltage reduction for the use case for the client based in part on the potential current profile for the use case for the client comprises:
retrieving a peak impedance for the client from a memory; and
identifying the voltage reduction for the use case for the client based on the potential current profile for the use case for the client and the peak impedance for the client.

7. A computing device, comprising:
a system power manager; and
a processor system coupled to the system power manager and configured to:
identify a potential current profile for a use case for the client;
identify a voltage reduction for the use case for the client based in part on the potential current profile for the use case for the client; and
transmit the voltage reduction for the use case for the client to the system power manager.

8. The computing device of claim 7, wherein identifying the potential current profile for the use case for the client comprises:
retrieving a maximum current for the client from a memory;
identifying a potential maximum current for the use case for the client; and
identifying the potential current profile for the use case for the client based on the maximum current for the client and the potential maximum current for the use case for the client.

9. The computing device of claim 8, wherein the voltage reduction for the use case for the client is configured to indicate to the system power manager to reduce a voltage to the client to a voltage level that maintains the voltage to the client at a level greater than a minimum voltage for the client during an occurrence of voltage droop corresponding to the potential maximum current for the use case for the client.

10. The computing device of claim 8, wherein identifying the potential maximum current for the use case for the client comprises calculating the potential maximum current for the use case for the client based on pending work for the use case for the client.

11. The computing device of claim 8, wherein identifying the potential maximum current for the use case for the client comprises retrieving the potential maximum current for the use case for the client from the memory.

12. The computing device of claim 11, wherein identifying the voltage reduction for the use case for the client based in part on the potential current profile for the use case for the client comprises:
retrieving a peak impedance for the client from the memory; and
identifying the voltage reduction for the use case for the client based on the potential current profile for the use case for the client and the peak impedance for the client.

13. A computing device, comprising:
means for identifying a potential current profile for a use case for the client;
means for identifying a voltage reduction for the use case for the client based in part on the potential current profile for the use case for the client; and
means for transmitting the voltage reduction for the use case for the client to a system power manager.

14. The computing device of claim 13, wherein means for identifying the potential current profile for the use case for the client comprises:
means for retrieving a maximum current for the client from a memory;
means for identifying a potential maximum current for the use case for the client; and
means for identifying the potential current profile for the use case for the client based on the maximum current for the client and the potential maximum current for the use case for the client.

15. The computing device of claim 14, wherein the voltage reduction for the use case for the client is configured to indicate to the system power manager to reduce a voltage to the client to a voltage level that maintains the voltage to the client at a level greater than a minimum voltage for the client during an occurrence of voltage droop corresponding to the potential maximum current for the use case for the client.

16. The computing device of claim 14, wherein means for identifying the potential maximum current for the use case for the client comprises means for calculating the potential maximum current for the use case for the client based on pending work for the use case for the client.

17. The computing device of claim 14, wherein means for identifying the potential maximum current for the use case for the client comprises means for retrieving the potential maximum current for the use case for the client from the memory.

18. The computing device of claim 13, wherein means for identifying the voltage reduction for the use case for the client based in part on the potential current profile for the use case for the client comprises:
means for retrieving a peak impedance for the client from a memory; and
means for identifying the voltage reduction for the use case for the client based on the potential current profile for the use case for the client and the peak impedance for the client.
